(19) United States
(12) Patent Application Publication
(10) Pub. No.: US 2011/0095612 A1
(43) Pub. Date: Apr. 28, 2011

(54) Method and apparatus to combine and condition AC power from multiple sources

(76) Inventor: William Kirkpatrick, Rutherford, NJ (US)

(21) Appl. No.: 12/589,305

(22) Filed: Oct. 22, 2009

(51) Int. Cl. H02M 7/02

(52) U.S. Cl. 307/77; 307/82

(57) ABSTRACT

This invention pertains to switching and combining more than one AC power supply using an internal controller that has external control and status functions available. The method taught in this invention is to convert all the AC power to DC, and, by varying the individual AC to DC converter output power, their contribution to the total power supplied is controlled, creating the ability to favor one source of electrical power instead of another. This is done under continuous control of a central controller that varies the DC output voltage of the individual AC to DC converter modules. The resulting DC power than goes to one or more invertors for conversion from DC to AC for general load consumption. An alternative embodiment has an electrical storage system in the DC portion of the system, so that a finite amount of energy can be stored and supplied at a later time, as needed and controlled by the central controller

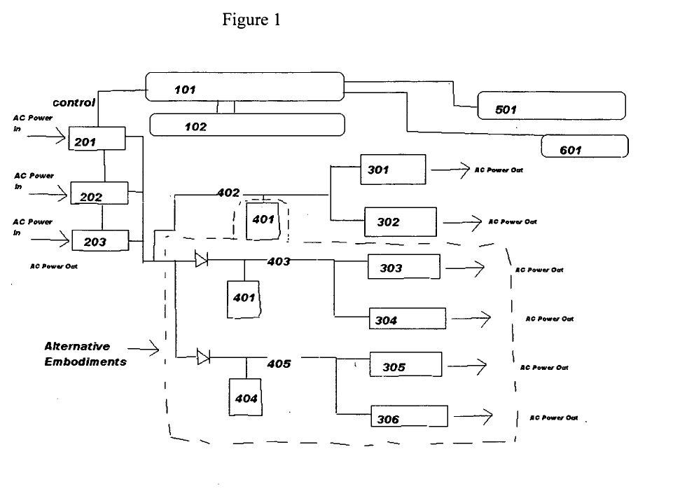

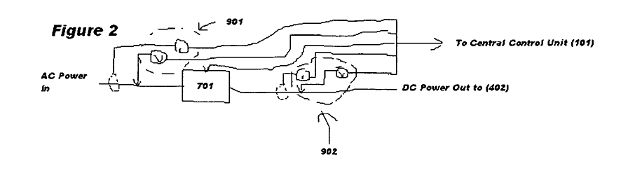

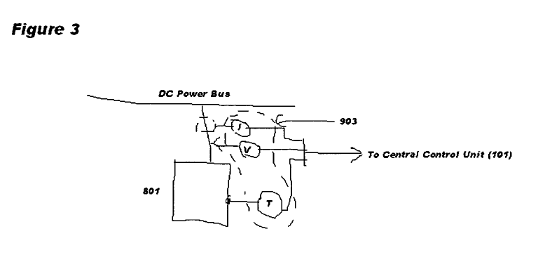

### CROSS REFERENCE TO OTHER APPLICATIONS

NONE

### STATEMENT REGARDING FEDERALLY SPONSORED RESEARCH AND DEVELOPMENT

N/A

### REFERENCE TO A SEQUENCE LISTING, A TABLE OR A COMPUTER PROGRAM LISTING COMPACT DISC APPENDIX

NONE

### DEFINITIONS

AC: Alternating Electrical Current
AC to DC Converter: An apparatus that is used to convert Alternating Electrical Current into Direct Electrical Current
DC: Direct Electrical Current
DC to AC converter: An apparatus used to convert Direct Electrical Current into Alternating Electrical Current

### SUMMARY

Briefly stated, in accordance with one aspect of the invention,—Electrical energy from-multiple sources is individually connected to the several controllable AC to DC converters to convert the incoming AC into DC, with each source contributing as directed by the central controlling unit. This DC is then routed to one or more DC to AC converters to convert the summed DC into AC power for utilization by various electrical loads.

In an alternate embodiment, a DC storage system is added to some or all of the DC portion of the power circuit allowing for the storage and release of DC electrical energy to compensate for any overage or shortage of supply at any given moment. As those skilled in the art would appreciate, the ability to store and release energy is not unlimited.

A significant difference to the current state of the art, this invention does not require that the systems inputs and outputs be physically located near each other. In fact, in an alternate embodiment, the inputs and outputs can be located hundreds of miles from each other

Another novel feature is the ability to have output parameter sensing, located electrically closer to the load, allowing the system to correct for effects that happen between the system outputs and the sensing point

In one use, this invention allows for the combining of several sources of electrical power, such as from wind turbines or a solar photovoltaic array, with power from a electric utility without ill effect to users. The system would draw all available power from the preferred sources, and use alternate sources to make up any energy shortfall, or, have the optional ability to store some or all of the energy for later use. Also, there are times when emergency power sources are tested in accordance with various legal requirements. Currently, this energy is converted into heat which is disposed of, instead of being put to a more productive use. This invention would allow these sources to be loaded as desired, and recover the energy.

In another user scenario, the ability to limit demand of power from selected sources to a certain level would allow for users to control the amount of electricity that is taken from sources that may charge more money during some time periods than during other time periods.

These uses are only some that this invention would allow, future users will most certainly use this invention in ways unforeseen at the present time, which are the spirit and included in this invention.

### BRIEF DESCRIPTION OF THE DRAWINGS

Many of the aspects and advantages will become more apparent and better understood by users when the following detailed description is taken in conjunction with the accompanying drawings, wherein:

Drawing 1 shows a schematic of the entire system, with alternate embodiments shown

Drawing 2 is a detail drawing of the input AC converters shown in drawing 1, with attention drawn to the amount of control and feedback given to the central processing unit.

Drawing 3 is a detail drawing of the DC energy component with attention drawn to the amount of control and feedback given to the central processing unit.

### DETAILED DESCRIPTION OF THE INVENTION

AC power from the main electrical source is supplied to the input of the AC to DC converter (201). Additional power sources are connected to the inputs of AC to DC converters (202, 203, . . . ) in sequence. There is no known theoretical limit to the number of AC to DC converters that a system has, limits, if any, are economic to the user. The AC to DC converters are typically of the high speed power switching type, enabling precise control of the output DC voltage of each AC to DC converter by the central control electronics. As those skilled in the art would appreciate, there are several methods of controlling the power in the AC to DC conversion process, such as turning on a silicon controlled rectifier at a certain point in the AC sine wave, using Insulated Gate Bipolar Transistors switch the power on and off at a frequency higher than the incoming power, and by varying the ratio of on to off time, are able to vary the module's output voltage and power. There exist other methods of varying the AC to DC converters output voltage, some not foreseen at this time, that will yield the same results. By precisely varying the output voltage of each AC to DC converter module in the system, the amount of power each module is supplying to the output DC bus can be controlled. The AC input voltage and current samples are sent to the central controller (101), as are the output DC voltage and current, while module drive signals are received from the central controller. The output DC power is than sent to the DC bus (402). A feature of this system is that the AC to DC converters do not need to be located near each other, the AC to DC converter modules can be separated by miles of distance, if desired, with no detrimental effect on system performance.

The power outputs of the AC to DC converters are connected to a DC power bus (402) which is connected to the power inputs of the AC invertors. In an alternate embodiment, DC power storage devices are connected to the DC power bus to assure the constant availability of DC power to the invertors. In another alternate embodiment, the AC to DC converters and invertors are separated in physical distance and some or all of the DC power bus is arranged in a ring configuration, so that any single interruption in the continuity of the ring will not affect the operation of the system. In this configuration, the control system would need to monitor each segment of the ring segment to prevent the overloading of any particular component of the ring. DC power is sent to the DC to AC converter section for conversion from DC power to AC power for utilization. In an alternate embodiment, the system has more than one DC to AC converter section. Possible uses of a system with a multiplicity of invertors could be redundancy of power at one voltage, different AC voltages, creating AC power system with varying phase offsets, creating non-standard poly-phase AC power systems, different frequency AC power systems. As a person skilled in the art would appreciate, this list of possible uses is not complete. The output of the modules would be monitored and controlled by the central control unit (101) In an alternate embodiment, the system output monitoring is placed electrically close to the load for greater accuracy

The central controller (101) receives inputs from the various power input and output modules, various statuses of system performance, such as voltage and current flow at a point in the system, and temperature to assure proper system performance. It would create the control signals for the various AC to DC converter and DC to AC converter modules so that they function in a system as desired.

In an alternate embodiment, the controller accepts external commands and sends status to external equipment, so that the capabilities of power generation and utilization may be better utilized by the system. External control could allow several of this inventions systems to function as a larger controlled system.

Within each input AC to DC converter module (201), there are several metering and control points, as shown on drawing II and now explained. Each phase of the incoming AC power supply is sampled for current flow and voltage, the samples are sent to the central controller (101) This drawing shows three such circuits, which is the preferred assembly for standard three phase power.

Shown on drawing III is a battery with the batteries voltage, temperature and current flow monitored by the central control unit (101). Once the incoming AC power has been converted to Direct current (DC), it is then placed on a bus (402) where all the modules output power is combined. In an alternative embodiment, there are one or more energy storage devices (401) connected to the DC bus.

The DC bus is also connected to one or more output invertors, which take the DC power from the bus and converted to alternating current using know and widely used DC to AC converter technologies. Input voltage and current, out voltage and current are sampled and sent to the central control unit, along with a temperature measurement of the DC to AC converters core temperature. In an alternative embodiment, a second DC bus is created with an energy storage device, with one or more invertors connected to the bus. The additional busses are then connected to the primary bus through steering diodes, to isolate the busses from each other, so that current in the system flows from AC to DC converter to DC to AC converter, and energy storage devices on one bus do not interact with another bus. In an alternative embodiment, the system consists of more than one DC to AC converter section providing power of similar or dissimilar characteristics, as desired by the system designer.

This invention will have many modifications and variations, all of which are in the scope of the claims

### BACKGROUND

This invention integrates two separate, though related areas of technology, the first of supplying continuous power, and the second of being able to combine sources of power as desired between several potential sources. The present technology of changing or combining sources of AC electrical energy utilizes switching, with voltages below 600 volts between conductors utilizing either mechanical or electrical switching. Most switching above 600 volts is mechanical, though there is a limited uses of semi-conductors. The draw back to either method when switching alternating current is that there is frequently a power disturbance due to a voltage or power cycle phase mis-match. To the end user of the electrical power, this disturbance will range in effect from barely perceptible to extremely damaging. The current best state of the art is to synchronize both sources of electrical power in both voltage and phase, connect the electrical loads to both sources at the same time, and then disconnect one of the sources. The time and considerable expense of being able to vary both phase and voltage with enough latitude limits the range of locations that this kind of switching can be done. If sources of electrical power could be switched and even combined at will with no detrimental effects, then the ability to utilize more environmentally friendly sources of electrical power would be more attractive to users. If two or more sources could be both utilized at the same time, with the desired source off electrical power being utilized to its maximum, and other sources being used to supply the remaining electrical power being demanded, a user could choose and even combine for optimal use between supplies of electrical power as they chose to, with no detrimental effect to the user.

The second, related area is that the present state of the art in the design and operation of Uninterruptible Power Systems is that they can only supply one kind of power output characteristics. Modern users of electrical power in a large amount will have more than one power system installed, each with different characteristics, most commonly different voltages. The current state of the art in the United Sates is to use 208 volts across each of 3 phases in a commercial application for some uses, and 480 volts between each of 3 phases for other, usually more electrical power consuming applications. Also, many users of Uninterruptible Power Systems will use several separate units to isolate the electrical users from each other, so that one user of electrical power will not put undesired effects on the power line that will affect other users.

The present invention solves both of these problems, by having the ability to have more than more than one source of electrical power supply more than one electrical user, each isolated from another. The functions of multiple inputs of electrical power is separate from the multiple outputs of electrical power.

What is claimed as new and desired to be secured by Letter of Patents of the United States is:

1) A power supply system that converts more than one Alternating current power source to direct current, that under the control of a central controller system adjusts the output voltage of each AC to DC converter, such that any combination of AC to DC converters, including any AC to DC converter alone is supplying DC power to a common DC bus as the central controller desires utilizing a system comprising of:
AC to DC converter assemblies which, under the control of a central control unit, vary the AC to DC converter output voltage to vary the AC to DC converter's output power that is placed on a Direct current bus, said DC bus is then further divided into a plurality of busses using diodes to isolate each of the new busses from each other, with one or more of said new DC busses connected to a DC energy storage device, each said new DC bus then directly connected to one or more invertors to convert the DC energy into AC electrical energy, with central control unit able to create responses to internal and external commands, system generated stimuli, and send data about the various elements of the entire unit to external devices.

2) The apparatus of claim 1, where output of said AC to DC converters is directly connected to the DC bus, which is then directly connected to the output DC to AC invertors.

3) The apparatus of claim 1, wherein said central controller utilizes at least one microprocessor

4) The apparatus of claim 1, wherein said DC bus has an energy storage component attached

5) The apparatus of claim 1, wherein the systems output performance is measured at a location other than the DC to AC DC to AC converter output terminals.

6) The apparatus of claim 1, wherein system has a panel mounted on the system for human interaction with the system.

7) The apparatus of claim 2, wherein said central controller utilizes at least one microprocessor

8) The apparatus of claim 2, wherein said DC bus has an energy storage component attached

9) The apparatus of claim 2, wherein the systems output performance is measured at a location other than the DC to AC DC to AC converter output terminals.

10) The apparatus of claim 2, wherein system has a panel mounted on the system for human interaction with the system.
